(19) United States
(12) Patent Application Publication
(10) Pub. No.: US 2024/0327948 A1
(43) Pub. Date: Oct. 3, 2024

(54) AUTOMATED METHOD AND DEVICE FOR PRODUCTION OF LEAD 212 FOR USE IN TARGETED ALPHA-PARTICLE THERAPY

(71) Applicant: RADIOMEDIX, INC., Houston, TX (US)

(72) Inventors: Ebrahim Delpassand, Houston, TX (US); Izabela Twoeowska, Houston, TX (US); Jared Jaksik, Conroe, TX (US)

(21) Appl. No.: 18/623,611

(22) Filed: Apr. 1, 2024

Related U.S. Application Data
(60) Provisional application No. 63/493,139, filed on Mar. 30, 2023.

(51) Int. Cl. C22B 13/06; B01D 15/18; B01D 15/36; B01D 15/42; C22B 3/02; C22B 3/04; C22B 3/24; C22B 3/42

(52) U.S. Cl. CPC C22B 13/06; B01D 15/1871; B01D 15/1885; B01D 15/362; B01D 15/426; C22B 3/02; C22B 3/04; C22B 3/24; C22B 3/42

(57) ABSTRACT

The present disclosure relates to an automated device and methods to produce a highly purified alpha-emitting radioisotope Pb-212 from a pre-filled column of a parent isotope Ra-224 for use in targeted alpha-particle therapy.

### CROSS-REFERENCE TO RELATED APPLICATION

This application claims priority to U.S. Provisional Application No. 63/493,139 filed on Mar. 30, 2023, which is hereby incorporated by reference in its entirety.

### FIELD OF THE INVENTION

The present disclosure relates to an automated device to produce highly purified alpha-emitting radioisotope Pb-212 from a pre-filled column of a parent isotope Ra-224 for use in targeted alpha-particle therapy.

### BACKGROUND OF THE INVENTION

Receptor-targeted cancer treatment remains a growing field of interest as research focuses on selectively delivering targeted treatment methods to tumors by chelation of small molecules that identify tumor-associated receptors, metabolic pathways, transporters, and antigens. These small molecules may include purified radioisotopes, which utilize a high-energy emission to powerfully target and destroy cancerous cells. The ability to diagnose certain cancers and damage the cancerous cells with limited effect on surrounding healthy tissue is a desirable mechanism with the potential to significantly advance an individual's treatment while minimizing toxic side-effects.

Therefore, targeted radionuclide therapy (TRT) has become an attractive and quickly developing therapy option for many diseases, including various types of cancers. While much research in the past has focused on betα-emitting particles, another form of targeted radionuclide therapy includes targeted alpha-particle therapy (TAT), which is a growing field directed to a method of purifying radioactive substances through alpha decay for use in targeting cancerous tissues with a high degree of specificity. α-emitting-particles are advantageous over β-emitting particles due to the high energy and short path length of the alpha articles. Furthermore, certain cancer tissues may be resistant to α-emitters and patients may suffer a number of side effects, giving α-emitting-particles a distinct advantage in targeted therapeutics.

In the art, various methods for producing and purifying radioisotopes have been found to show great potential in TRT and TAT treatments, and in particular Pb-212 has shown promise in the development of new therapies that target cancer cells while minimizing impact on healthy tissue. Early studies into Pb-212 as an α-emitting radionuclide showed increased efficiency in killing human ovarian cancer cells compared to x-ray therapy. Pb-212 has been the focus of several clinical trials, including a phase I clinical trial with Pb-212-TCMC-trastuzumab at the University of Alabama, Birmingham, showing minimal toxicity levels when used to treat ovarian cancer. Recently, first-in-Humans Dose-Escalation Clinical Trial using Targeted Alpha-Emitter Therapy (TAT) with Pb-212-DOTAMTATE for the Treatment of Metastatic SSTR-Expressing Neuroendocrine Tumors revealed that alpha-therapy with Pb-212-DOTAMTATE to be well tolerated and efficacious. A phase II trial for the use of Pb-212-DOTAMTATE in TAT treatments of patients with somatostatin receptor-expressing neuroendocrine tumors (NET) is ongoing.

Pb-212 is a daughter product of the Th-228 radioactive family. Th-228 has a half-life of about 1.9 years. Ra-224 falls within the same radioactive decay chain and has been used as a generator to obtain continuous amounts of Pb-212 through radioactive decay. Typically, the generator is a device containing the Ra-224 bound to an exchange resin, and the Pb-212 is recovered by elution. The Pb-212 containing eluate undergoes acid digestion to remove chemical impurities.

Various deficiencies exist with current methods of purifying and using such purified Pb-212, including potential accumulation of the radioactive isotope in the patient's bone marrow and other side-effects resulting from the natural toxicity of any accrued free lead. Current methods provide only low levels of purification and consequently require low dosages of the therapeutic drugs to avoid unintended and dangerous side-effects. Due to the impact of potential toxicity, there is a significant disadvantage to using less purified radioisotopes in TAT treatments.

Thus, there is an unmet need for improved processes for generating Pb-212, e.g. to reduce the impact of impurities and radioisotope toxicity. There also exists a clinical need for efficient processes for generating purified Pb-212 for improved and effective targeted alpha-particle therapy.

The present invention provides methods for improved Pb-212 purification and use. The invention includes improved purification systems for Targeted Alpha-particle Therapy employing purification resins, higher activities of the isotopes, and radiation shielding of columns containing the isotopes. The invention leads to a more streamlined process of producing alpha emitter treatments that provide advantages of previous methods of treatment but with increased purity, causing lower rates of toxicity in patients. Processes of the invention allow higher activities of reagents and products, facilitate scale up and commercial manufacturing of Pb-212. In addition, the invention provides more effective radiation shielding for improved public safety and ease of transportation during shipping.

### SUMMARY OF THE INVENTION

Among the various aspects of the present disclosure are methods and devices for the automated production of Pb-212 from parent radionuclide Th-228. The produced Pb-212 performs as a radioactive component of radiopharmaceuticals for different Targeted Alpha-particle-Therapy and is particularly useful in the treatment of various cancers including but not limited to cancer of the pancreas, brain, ovaries, prostate, colon, breast, and neuroendocrine tumors.

The produced Pb-212 is highly purified and, when labeled with specific ligands and dosed to patients in need thereof, results in lower toxicity profiles and reduced free lead accumulation in the bone marrow, providing better effects and fewer adverse effects than Pb-212 generated through other methods or other comparable beta-particle treatments.

The process of producing radionuclides may be implemented through an automated module sequence to more efficiently synthesize the necessary radionuclides.

The parent radioisotope may be selected from Th-228, or directly from Ra-224.

Radioisotopes produced by the processes of the invention may be combined with chelators and other molecules for TAT. The chelators include those selected from the group consisting of DOTA, DOTAM, TCMC, and derivatives thereof.

The purification methods used to produce the radionuclide can and will vary, as the efficacy of a radionuclide is dependent on its purity and amount of free radiation. The purification resin used in the composition can and will vary. In some embodiments, the purification resin used may be selected from the group consisting of Bio-Rad AGMP1, Bio-Rad AMP50, Bio-Rad AG50W, Bio-Rad Chelex 100, Purolite NRW100, Purolite NRW1100, Purolite NRW1160, Purolite NRW1160LS, Purolite NRW150, Purolite NRW160, Purolite NRW160LS, TrisKem Actinide resin, TrisKem DGA resin, TrisKem Guard resin, TrisKem KNiFC-PAN resin, TrisKem LN resin, TrisKem LN2 resin, TrisKem LN3 resin, TrisKem MNO2-PAN resin, TrisKem NI resin, TrisKem PB resin, TrisKem Prefilter resin, TrisKem RE resin, TrisKem SR resin, TrisKem TBP resin, TrisKem TEVA resin, TrisKem TK100 resin, TrisKem TK101 resin, TrisKem TK102 resin, TrisKem TK200 resin, TrisKem TK201 resin, TrisKem TK202 resin, TrisKem TK211 resin, TrisKem TK212 resin, TrisKem TK213 resin, TrisKem TK221 resin, TrisKem TK225 resin, TrisKem TK400 resin, TrisKem TRU resin, TrisKem UTEVA resin, TrisKem WBEC resin, and TrisKem ZR resin. TrisKem resin can also be referred to as TK resin. Persons skilled in the art can appreciate the use of various ion exchange resins suitable for use under the present invention.

The level of activity of the parent isotope loaded in single and multiple columns can and will vary. In some embodiments, the level of activity ranges from at least 5 mCi, at least 10 mCi, at least 15 mCi, at least 20 mCi, at least 25 mCi, at least 30 mCi, at least 35 mCi, at least 40 mCi, at least 45 mCi, at least 50 mCi, at least 55 mCi, at least 60 mCi, at least 65 mCi, at least 70 mCi, at least 75 mCi, at least 80 mCi, at least 85 mCi, at least 90 mCi, at least 95 mCi, at least 100 mCi, at least 105 mCi, at least 110 mCi, at least 115 mCi, at least 120 mCi, at least 125 mCi, at least 130 mCi, at least 135 mCi, at least 140 mCi, at least 145 mCi, at least 150 mCi, at least 155 mCi, at least 160 mCi, at least 165 mCi, at least 170 mCi, at least 175 mCi, at least 180 mCi, at least 185 mCi, at least 190 mCi, at least 195 mCi, or at least 200 mCi.

The dosage of the resulting Pb-212 drug can and will vary. In some embodiments, the total dosage of ²¹²Pb present in the radiopharmaceutical composition may range from about 1 mCi to 5 mCi, about 5 mCi to 10 MCi, about 10 mCi to 15 mCi, about 15 mCi to 20 mCi, 20 mCi to 30 mCi, about 15 mCi to 25 mCi, about 25 mCi to 35 mCi, about 30 mCi to 40 mCi, about 35 mCi to 45 mCi, about 40 mCi to 50 mCi, or about 45 mCi to 55 mCi, The dosage may be about 15 mCi, 20 mCi, 25 mCi, 30 mCi, 35 mCi, 40 mCi, 45 mCi, 50 mCi, or 55 mCi.

Other features of the invention are described in detail below.

### BRIEF DESCRIPTION OF THE DRAWINGS

FIG. 1 depicts a first embodiment of a device comprising a single multi-port head-valve with a number of valves that control the flow of solvents, eluates, and buffers in the automated production of Pb-212 from parent radionuclide Ra-224.

FIG. 2 depicts a second embodiment of a device comprising a multi-port head-valve with a number of valves that allow for further selectivity in the flows of solvents, eluates, and buffers post-elution of Pb-212 from parent radionuclide Ra-224.

FIG. 3 depicts a third embodiment of the device comprising a multi-port head-valve with valves that allow for selectivity in the flow of solvents, eluates, and buffers post-purification of Pb-212.

FIG. 4 depicts the schematic layout of the automated sequence used for the purification of Th-228 and Ra244.

FIG. 5. illustrates a scheme for Pb-212 purification using a tertiary amine-based resin, e.g. TK resin.

FIG. 6. depicts the fractionated elution profile of Pb-212 from TK resin.

FIG. 7 depicts the yield (RCY %) of Pb-212 after loading and Pb-212 elution from the pre-purification column.

FIG. 8 depicts an embodiment of an automated system for Th-228 and Ra-224 purification.

FIG. 9. depicts an embodiment of an automated system for elution and post-purification of Pb-212.

FIG. 10. depicts layouts of a housing for a device for the elution and purification of Pb-212: (a) isometric view, (b) side view, (c) top view.

### DETAILED DESCRIPTION OF THE INVENTION

Disclosed herein is an automated device to produce the highly purified, alpha-emitting radioisotope Pb-212 from a pre-filled column of a parent isotope Ra-224. The purified Pb-212 can be used in targeted alpha-particle therapy.

The description that follows includes exemplary device, methods, techniques, and/or instructions that embody techniques of the present subject matter. However, it is understood that the described embodiments may be practiced without these specific details.

When introducing elements of the various embodiment(s) of the present disclosure, the articles “a”, “an”, “the” and “said” are intended to mean that there are one or more of the elements. The terms “comprising”, “including” and “having” are intended to be inclusive and mean that there may be additional elements other than the listed elements.

The use of individual numerical values are stated as approximations as though the values were preceded by the word “about” or “approximately.” Similarly, the numerical values in the various ranges specified in this application, unless expressly indicated otherwise, are stated as approximations as though the minimum and maximum values within the stated ranges were both preceded by the word “about” or “approximately.” In this manner, variations above and below the stated ranges can be used to achieve substantially the same results as values within the ranges. As used herein, the terms “about” and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about” or “approximately” will serve to broaden a particular numerical value or range. Thus, as a general matter, “about” or “approximately” broaden the numerical value. Also, the disclosure of ranges is intended as a continuous range including every value between the minimum and maximum values plus the broadening of the range afforded by the use of the term “about” or “approximately.” Consequently, recitation of ranges of values herein are merely intended to serve as a shorthand method of referring individually to each separate value falling within the range, unless otherwise indicated herein, and each separate value is incorporated into the specification as if it were individually recited herein.

The term “half-life” as used herein, refers to the time required for physical decay of a radioisotope to 50% of the initial/starting activity, and a drug's blood or plasma concentration to decrease by one half. This decrease in drug concentration is a reflection of its excretion or elimination after absorption is complete and distribution has reached an equilibrium or quasi equilibrium state. The half-life of a drug in the blood may be determined graphically off of a pharmacokinetic plot of a drug's blood-concentration time plot, typically after intravenous administration to a sample population. The half-life can also be determined using mathematical calculations that are well known in the art. Further, as used herein the term “half-life” also includes the “apparent half-life” of a drug. The apparent half-life may be a composite number that accounts for contributions from other processes besides elimination, such as absorption, reuptake, or enterohepatic recycling.

The term “active agent” or “drug,” as used herein, refers to any chemical that elicits a biochemical response when administered to a human or an animal. The drug may act as a substrate or product of a biochemical reaction, or the drug may interact with a cell receptor and elicit a physiological response, or the drug may bind with and block a receptor from eliciting a physiological response.

The terms “subject” or “patient” are used interchangeably herein and refer to a vertebrate, preferably a mammal. Mammals include, but are not limited to, humans.

The term “pure” or “purity” refers to chemical purity or radiological purity. Wherein, radiological purity refers to the purity of one radionuclide with respect to other radionuclides from which it originates by radioactive decay, as well as with regard to other radionuclides that are not part of its radioactive decay chain.

The terms “isotope,” “radioisotope,” and “radionuclide” are all used to mean a nuclide that is unstable and naturally undergoes radioactive decay over time.

The term “parent nuclide” refers to a radionuclide before radioactive decay into daughter radionuclides within its known radioactive decay chain.

The term “daughter nuclide” refers to a radionuclide that has undergone radioactive decay stemming from a larger parent nuclide within its known radioactive decay chain.

An embodiment of the invention is the use and manipulation of parent nuclides and daughter nuclides. These nuclides may be selected from the group consisting of ²¹²Pb, ²⁰³Pb, ⁸⁴Cu, ⁶⁷Cu, ²¹²Bi, ⁶⁸Ga, ²¹²Bi, ²¹³Bi, ²²³Ra, ²²⁴Ra, ²²⁵Ac, ²⁴³Am, ²¹¹At, ²¹⁷At, ¹⁵⁴Dy, ¹⁴⁸Gd, ¹⁴⁶Sm, ¹⁴⁷Sm, ¹⁴⁹Tb, ²²⁷Th, ²²⁸Th, ²²⁹Th, ⁵⁹Fe, ⁶⁰Cu, ⁶¹Cu, ⁶²Cu, ⁶¹Ga, ⁸⁶Y, ¹¹¹In, ¹⁵³Gd, ¹⁵³Sm, and ¹⁶⁶Ho. More specifically, these nuclides may be chosen from nuclides of thorium, radium, actinium, radon, polonium, lead, and bismuth. Even more specifically, parent nuclides consist of thorium-228 or radium-224, and daughter nuclides consist of Pb-212 and bismuth-212. Even more specifically, the daughter nuclide is Pb-212.

The parent radionuclide loaded on a single column has an activity level of at least 1 mCi, at least 2 mCi, at least 3 mCi, at least 4 mCi, at least 5 mCi, at least 6 mCi, at least 7 mCi, at least 8 mCi, at least 9 mCi, at least 10 mCi, at least 11 mCi, at least 12 mCi, at least 13 mCi, at least 14 mCi, at least 15 mCi, at least 16 mCi, at least 17 mCi, at least 18 mCi, at least 19 mCi, at least 20 mCi, at least 21 mCi, at least 22 mCi, at least 23 mCi, at least 24 mCi, at least 25 mCi, at least 26 mCi, at least 27 mCi, at least 28 mCi, at least 29 mCi, at least 30 mCi, at least 31 mCi, at least 32 mCi, at least 33 mCi, at least 34 mCi, at least 35 mCi, at least 36 mCi, at least 37 mCi, at least 38 mCi, at least 39 mCi, at least 40 mCi, at least 41 mCi, at least 42 mCi, at least 43 mCi, at least 44 mCi, at least 45 mCi, at least 46 mCi, at least 47 mCi, at least 48 mCi, at least 49 mCi, at least 50 mCi, at least 55 mCi, at least 60 mCi, at least 65 mCi, at least 70 mCi, at least 75 mCi, at least 80 mCi, at least 85 mCi, at least 90 mCi, at least 95 mCi, at least 100 mCi, at least 105 mCi, at least 110 mCi, at least 115 mCi, at least 120 mCi, at least 125 mCi, at least 130 mCi, at least 135 mCi, at least 140 mCi, at least 145 mCi, at least 150 mCi, at least 155 mCi, at least 160 mCi, at least 165 mCi, at least 170 mCi, at least 175 mCi, at least 180 mCi, at least 185 mCi, at least 190 mCi, at least 195 mCi, or at least 200 mCi. In other embodiments, parent radionuclide has an activity level of about 5 mCi to about 100 mCi. In yet another embodiment, the parent radionuclide has an activity level of about 5 mCi to about 50 mCi. In still another embodiment, the parent radionuclide has an activity level of about 5 mCi to about 50 mCi.

An embodiment of the invention includes a method and device for producing the purified desired daughter nuclide for use in medicine. One embodiment comprises the production of the daughter nuclide by radioactive decay of a parent nuclide contained within a first solid medium to which the parent nuclide is bound. The extraction of the daughter nuclide from the first solid medium is in the form of an aqueous solution. The method further comprises radiological and chemical purification of the daughter nuclide in said aqueous solution via a second solid medium through which the said aqueous solution is passed, binding the daughter nuclide and eluting radiological and chemical impurities. The daughter nuclide is then eluted from the second solid medium to provide the purified daughter nuclide.

An embodiment of the invention includes a method and device for producing purified desired daughter nuclides for use in medicine via the decay of a parent nuclide in a device comprising a first solid media that binds the parent nuclide but does not bind the daughter nuclide.

A more specific embodiment of the invention includes a method and device for producing purified Pb-212 for use in medicine via the decay of thorium-228 or radium-224 in a device containing one or more of a first solid media that binds thorium-228 or radium-224 but does not bind Pb-212.

In one embodiment of the invention, a solid media binding thorium-228 or radium-224 is a column comprising a cation exchange resin. More specifically, an embodiment of the invention uses Bio-Rad AGMP1 resin as the cation exchange resin. Another embodiment of the invention uses Bio-Rad AMP50 resin. Yet another embodiment of the invention uses Bio-Rad AG50W resin. Yet another embodiment of the invention uses Bio-Rad Chelex 100 resin. Yet another embodiment of the invention uses Purolite NRW100 resin. Yet another embodiment of the invention uses Purolite NRW1100 resin. Yet another embodiment of the invention uses Purolite NRW1160 resin. Yet another embodiment of the invention uses Purolite NRW1160LS resin. Yet another embodiment of the invention uses Purolite NRW150 resin. Yet another embodiment of the invention uses Purolite NRW160 resin. Yet another embodiment of the invention uses Purolite NRW160LS resin. Other embodiments of the invention use TrisKem resin (TK resin). One other embodiment of the invention uses TrisKem Actinide resin. Another embodiment of the invention uses TrisKem DGA resin. Yet another embodiment of the invention uses TrisKem Guard resin. Yet another embodiment of the invention uses TrisKem KNiFC-PAN resin. Yet another embodiment of the invention uses TrisKem LN resin. Yet another embodiment of the invention uses TrisKem LN2 resin. Yet another embodiment of the invention uses TrisKem LN3 resin. Yet another embodiment of the invention uses TrisKem MNO2-PAN resin. Yet another embodiment of the invention uses TrisKem NI resin. Yet another embodiment of the invention uses TrisKem PB resin. Yet another embodiment of the invention uses TrisKem Prefilter resin. Yet another embodiment of the invention uses TrisKem RE resin. Yet another embodiment of the invention uses TrisKem SR resin. Yet another embodiment of the invention uses TrisKem TBP resin. Yet another embodiment of the invention uses TrisKem TEVA resin. Yet another embodiment of the invention uses TrisKem TK100 resin. Yet another embodiment of the invention uses TrisKem TK101 resin. Yet another embodiment of the invention uses TrisKem TK102 resin. Yet another embodiment of the invention uses TrisKem TK200 resin. Yet another embodiment of the invention uses TrisKem TK201 resin. Yet another embodiment of the invention uses TrisKem TK202 resin. Yet another embodiment of the invention uses TrisKem TK211 resin. Yet another embodiment of the invention uses TrisKem TK212 resin. Yet another embodiment of the invention uses TrisKem TK213 resin. Yet another embodiment of the invention uses TrisKem TK221 resin. Yet another embodiment of the invention uses TrisKem TK225 resin. Yet another embodiment of the invention uses TrisKem TK400 resin. Yet another embodiment of the invention uses TrisKem TRU resin. Yet another embodiment of the invention uses TrisKem UTEVA resin. Yet another embodiment of the invention uses TrisKem WBEC resin. Yet another embodiment of the invention uses TrisKem ZR resin. Persons skilled in the art can appreciate that the use of other various ion exchange resins suitable for use in the present invention.

In one embodiment of the invention, the parent nuclide, while bound to the resin, produces Pb-212 via radioactive decay, which can be eluted from the resin.

A specific embodiment of the invention comprises the use of water or an aqueous solution to elute the Pb-212 that does not bind to the resin. More specifically, the aqueous solution can be an aqueous acid solution. As an example, the acid can be hydrochloric acid. In another example, the acid can be nitric acid. In another embodiment, the aqueous solution is a buffer solution. As an example, the buffer solution can be a sodium acetate buffer solution. In another example, the buffer solution can be an ammonium acetate buffer solution. The concentration may or may not be adjusted to yield a pH suitable for the elution of Pb-212. In embodiments of the invention, the buffer concentration may be from about 0.1 M to about 1M, from about 0.1 M to about 0.9 M, from about 0.2 M to about 0.8 M, from about 0.3 M to about 0.7 M, from about 0.3M to about 0.6 M, or from about 0.4 M to about 0.5 M. In one embodiment of the invention, the elution of Pb-212 is carried out at a pH from about 4.5 to about 7.5, from about 4.6 to about 7.4, from about 4.7 to about 7.3, from about 4.8 to about 7.2, from about 4.9 to about 7.1, from about 5.0 to about 7.0, from about 5.1 to about 6.9, from about 5.2 to about 6.8, from about 5.3 to about 6.7, from about 5.4 to about 6.6, from about 5.5 to about 6.5, from about 5.6 to about 6.4, from about 5.7 to about 6.3, from 5.8 to about 6.2, from about 5.9 to about 6.1, from about 6.0 to about 6.1, or from about 5.8 to about 6.0. In another embodiment, the pH is about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, or about 7.5.

An embodiment of the invention includes that there is at least one column used in the elution of Pb-212. For example, one column is used to elute Pb-212. In another example, two columns are used to elute Pb-212. In another example, three columns are used to elute Pb-212. In another example, four columns are used to elute Pb-212. In another example, five columns are used to elute Pb-212. In another example, six columns are used to elute Pb-212. In another example, seven columns are used to elute Pb-212. In another example, eight columns are used to elute Pb-212. In another example, nine columns are used to elute Pb-212. In another example, ten columns are used to elute Pb-212.

An embodiment of the invention includes that the columns used in the previous embodiments are connected in series. In another embodiment, the columns used in the previous embodiments are connected in parallel.

An embodiment of the invention is that the column or columns used in the previous embodiments comprise radiation shielding. In another embodiment of the invention, each individual column is equipped with radiation shielding. In yet another embodiment of the invention, all columns together are equipped with radiation shielding. Said radiation shielding comprises materials effective in blocking radiation and allowing exposure to users of the invention to radiation at safe levels. Radiation shielding can comprise lead, depleted uranium, antimony, tungsten, tin, bismuth, cerium, or telluride. Said radiation shielding also can also comprise material or materials comprising polymer composites of lead, depleted uranium, antimony, tungsten, tin, bismuth, cerium, or telluride. Said radiation shielding can comprise single-walled carbon nanotubes (SWNTs), or boron nitride nanotubes (BNNTs). Said radiation shielding can have a thickness from about 0.01 mm to about 0.04 mm, from about 0.05 mm to about 0.09 mm, from about 0.10 mm to about 0.99 mm, from about 1.00 mm to about 1.99 mm, from about 2.00 mm to about 2.99 mm, from about 3.00 mm to about 3.99 mm, from about 4.00 mm to about 4.99 mm, from about 5.00 mm to about 5.99 mm, from about 6.00 mm to about 6.99 mm, from about 7.00 mm to about 7.99 mm, from about 8.00 mm to about 8.99 mm, from about 9.00 mm to about 9.99 mm, from about 1.00 cm to about 1.99 cm, from about 2.00 cm to about 2.99 cm, from about 3.00 cm to about 3.99 cm, from about 4.00 cm to about 4.99 cm, from about 5.00 cm to about 5.99 cm, from about 6.00 cm to about 6.99 cm, from about 7.00 cm to about 7.99 cm, from about 8.00 cm to about 8.99 cm, or from about 9.00 cm to about 9.99 cm.

The resulting aqueous solution of containing Pb-212 of the previous embodiments can be further purified using one or more of a second solid media.

In one embodiment, a second solid media can be contained in a column which retains Pb-212 from the aqueous solution and elutes any radiological and chemical impurities away from the Pb-212.

In an embodiment of the invention, the second solid media is a chromatography column used to purify Pb-212. More specifically, the second solid media that binds Pb-212 can be a liquid chromatography column used to purify Pb-212. In another embodiment the liquid chromatography column comprises a resin. In a more specific embodiment the resin is Bio-Rad AGMP1 resin. Another embodiment of the invention uses Bio-Rad AMP50 resin. Yet another embodiment of the invention uses Bio-Rad AG50W resin. Yet another embodiment of the invention uses Bio-Rad Chelex 100 resin. Yet another embodiment of the invention uses Purolite NRW100 resin. Yet another embodiment of the invention uses Purolite NRW1100 resin. Yet another embodiment of the invention uses Purolite NRW1160 resin. Yet another embodiment of the invention uses Purolite NRW1160LS resin. Yet another embodiment of the invention uses Purolite NRW150 resin. Yet another embodiment of the invention uses Purolite NRW160 resin. Yet another embodiment of the invention uses Purolite NRW160LS resin. Other embodiments of the invention use TrisKem resin (TK resin). Yet another embodiment of the invention uses TrisKem Actinide resin. Another embodiment of the invention uses TrisKem DGA resin. Yet another embodiment of the invention uses TrisKem Guard resin. Yet another embodiment of the invention uses TrisKem KNiFC-PAN resin. Yet another embodiment of the invention uses TrisKem LN resin. Yet another embodiment of the invention uses TrisKem LN2 resin. Yet another embodiment of the invention uses TrisKem LN3 resin. Yet another embodiment of the invention uses TrisKem MNO2-PAN resin. Yet another embodiment of the invention uses TrisKem NI resin. Yet another embodiment of the invention uses TrisKem PB resin. Yet another embodiment of the invention uses TrisKem Prefilter resin. Yet another embodiment of the invention uses TrisKem RE resin. Yet another embodiment of the invention uses TrisKem SR resin. Yet another embodiment of the invention uses TrisKem TBP resin. Yet another embodiment of the invention uses TrisKem TEVA resin. Yet another embodiment of the invention uses TrisKem TK100 resin. Yet another embodiment of the invention uses TrisKem TK101 resin. Yet another embodiment of the invention uses TrisKem TK102 resin. Yet another embodiment of the invention uses TrisKem TK200 resin. Yet another embodiment of the invention uses TrisKem TK201 resin. Yet another embodiment of the invention uses TrisKem TK202 resin. Yet another embodiment of the invention uses TrisKem TK211 resin. Yet another embodiment of the invention uses TrisKem TK212 resin. Yet another embodiment of the invention uses TrisKem TK213 resin. Yet another embodiment of the invention uses TrisKem TK221 resin. Yet another embodiment of the invention uses TrisKem TK225 resin. Yet another embodiment of the invention uses TrisKem TK400 resin. Yet another embodiment of the invention uses TrisKem TRU resin. Yet another embodiment of the invention uses TrisKem UTEVA resin. Yet another embodiment of the invention uses TrisKem WBEC resin. Yet another embodiment of the invention uses TrisKem ZR resin. Persons skilled in the art can appreciate that the use of other various ion exchange resins are suitable under the present invention.

In an embodiment of the methods of the invention, the radiological and chemical impurities that do not bind to the resin are eluted from the resin via water or an aqueous solution. More specifically, the aqueous solution can be an aqueous acid solution. As an example, the acid can be hydrochloric acid. In another example, the acid can be nitric acid. In another embodiment, the aqueous solution is a buffer solution. As an example, the buffer solution can be a sodium acetate buffer solution. In another example, the buffer solution can be an ammonium acetate buffer solution. The concentration may or may not be adjusted to yield a pH suitable for the elution of radiological and chemical impurities. In embodiments of the invention, the buffer concentration may be from about 0.1 M to about 1M, from about 0.1 M to about 0.9 M, from about 0.2 M to about 0.8 M, from about 0.3 M to about 0.7 M, from about 0.3M to about 0.6 M, or from about 0.4 M to about 0.5 M. In one embodiment of the invention the elution of radiological and chemical impurities is carried out at a pH from about 4.5 to about 7.5, from about 4.6 to about 7.4, from about 4.7 to about 7.3, from about 4.8 to about 7.2, from about 4.9 to about 7.1, from about 5.0 to about 7.0, from about 5.1 to about 6.9, from about 5.2 to about 6.8, from about 5.3 to about 6.7, from about 5.4 to about 6.6, from about 5.5 to about 6.5, from about 5.6 to about 6.4, from about 5.7 to about 6.3, from 5.8 to about 6.2, or from about 5.9 to about 6.1, from about 6.0 to about 6.1, or from about 5.8 to about 6.0. In another embodiment, the pH is about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, or about 7.5. The solid phase of the liquid chromatography column may be washed to elute radiological and chemical impurities from the bound Pb-212.

An embodiment of the invention includes that there is at least one column used in the elution of radiological and chemical impurities from Pb-212. For example, one column is used to elute radiological and chemical impurities. In another example, two columns are used to elute radiological and chemical impurities. In another example, three columns are used to elute radiological and chemical impurities. In another example, four columns are used to elute radiological and chemical impurities. In another example, five columns are used to elute radiological and chemical impurities. In another example, six columns are used to elute radiological and chemical impurities. In another example, seven columns are used to elute radiological and chemical impurities. In another example, eight columns are used to elute radiological and chemical impurities. In another example, nine columns are used to elute radiological and chemical impurities. In another example, ten columns are used to elute radiological and chemical impurities.

In one embodiment of the invention, the columns are connected in series. In another embodiment, the columns are connected in parallel.

In other embodiments, each individual column is equipped with radiation shielding. In another embodiment, each individual column is equipped with radiation shielding. In yet another embodiment, all columns together are equipped with radiation shielding. Said radiation shielding comprises materials effective in blocking radiation and allowing exposure to users of the invention to radiation at safe levels. Radiation shielding can comprise lead, depleted uranium, antimony, tungsten, tin, bismuth, cerium, or telluride. Radiation shielding can also comprise polymer composites of lead, depleted uranium, antimony, tungsten, tin, bismuth, cerium, or telluride. Radiation shielding can comprise single-walled carbon nanotubes (SWNTs), or boron nitride nanotubes (BNNTs). Said radiation shielding has a thickness from about 0.01 mm to about 0.04 mm, from about 0.05 mm to about 0.09 mm, from about 0.10 mm to about 0.99 mm, from about 1.00 mm to about 1.99 mm, from about 2.00 mm to about 2.99 mm, from about 3.00 mm to about 3.99 mm, from about 4.00 mm to about 4.99 mm, from about 5.00 mm to about 5.99 mm, from about 6.00 mm to about 6.99 mm, from about 7.00 mm to about 7.99 mm, from about 8.00 mm to about 8.99 mm, from about 9.00 mm to about 9.99 mm, from about 1.00 cm to about 1.99 cm, from about 2.00 cm to about 2.99 cm, from about 3.00 cm to about 3.99 cm, from about 4.00 cm to about 4.99 cm, from about 5.00 cm to about 5.99 cm, from about 6.00 cm to about 6.99 cm, from about 7.00 cm to about 7.99 cm, from about 8.00 cm to about 8.99 cm, or from about 9.00 cm to about 9.99 cm.

After removing radiological and chemical impurities from the liquid chromatography column, the purified Pb-212 can be eluted using water or an aqueous solution. More specifically, the aqueous solution can be an aqueous acid solution. As an example, the acid can be hydrochloric acid. In another example, the acid can be nitric acid. In another embodiment, the aqueous solution is a buffer solution. As an example, the buffer solution can be a sodium acetate buffer solution. In another example, the buffer solution can be an ammonium acetate buffer solution. The concentration may or may not be adjusted to yield a pH suitable for the elution of Pb-212. In embodiments of the invention, the buffer concentration may be from about 0.1 M to about 1M, from about 0.1 M to about 0.9 M, from about 0.2 M to about 0.8 M, from about 0.3 M to about 0.7 M, from about 0.3M to about 0.6 M, or from about 0.4 M to about 0.5 M. In one embodiment of the invention the elution of Pb-212 is carried out at a pH from about 4.5 to about 7.5, from about 4.6 to about 7.4, from about 4.7 to about 7.3, from about 4.8 to about 7.2, from about 4.9 to about 7.1, from about 5.0 to about 7.0, from about 5.1 to about 6.9, from about 5.2 to about 6.8, from about 5.3 to about 6.7, from about 5.4 to about 6.6, from about 5.5 to about 6.5, from about 5.6 to about 6.4, from about 5.7 to about 6.3, from 5.8 to about 6.2, or from about 5.9 to about 6.1, from about 6.0 to about 6.1, or from about 5.8 to about 6.0. In another embodiment, the pH is about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, or about 7.5.

Preferably, the radiological purity of Pb-212 produced by the invention is greater than or equal to about 90%. More preferably, the radiological purity of Pb-212 produced by the invention is greater than or equal to about 95%. In another embodiment, the radiological purity of Pb-212 is greater than or equal to 99.5%. Preferably, the radiological purity of Pb-212 is greater than or equal to 99.95%. Preferably, the radiological purity of Pb-212 is greater than or equal to 99.995%.

The purified Pb-212 can have a radioactive concentration (or radioactivity) of at least 1 mCi, at least 2 mCi, at least 3 mCi, at least 4 mCi, at least 5 mCi, at least 6 mCi, at least 7 mCi, at least 8 mCi, at least 9 mCi, at least 10 mCi, at least 11 mCi, at least 12 mCi, at least 13 mCi, at least 14 mCi, at least 15 mCi, at least 16 mCi, at least 17 mCi, at least 18 mCi, at least 19 mCi, at least 20 mCi, at least 21 mCi, at least 22 mCi, at least 23 mCi, at least 24 mCi, at least 25 mCi, at least 26 mCi, at least 27 mCi, at least 28 mCi, at least 29 mCi, at least 30 mCi, at least 31 mCi, at least 32 mCi, at least 33 mCi, at least 34 mCi, at least 35 mCi, at least 36 mCi, at least 37 mCi, at least 38 mCi, at least 39 mCi, at least 40 mCi, at least 41 mCi, at least 42 mCi, at least 43 mCi, at least 44 mCi, at least 45 mCi, at least 46 mCi, at least 47 mCi, at least 48 mCi, at least 49 mCi, at least 50 mCi, at least 55 mCi, at least 60 mCi, at least 65 mCi, at least 70 mCi, at least 75 mCi, at least 80 mCi, at least 85 mCi, at least 90 mCi, at least 95 mCi, at least 100 mCi. Preferably, the purified Pb-212 has a radioactive concentration of about 1-9 mCi, about 10-19 mCi, about 20-29 mCi, about 30-39 mCi, about 40-49 mCi, about 50-59 mCi, about 60-69 mCi, about 70-79 mCi, about 80-89 mCi, about 90-100 mCi, or about 1-100 mCi.

The dosage of the resulting Pb-212 drug can and will vary. In some embodiments, the total dosage of Pb-212 present in a radiopharmaceutical composition may be at least 1 mCi, at least 2 mCi, at least 3 mCi, at least 4 mCi, at least 5 mCi, at least 6 mCi, at least 7 mCi, at least 8 mCi, at least 9 mCi, at least 10 mCi, at least 11 mCi, at least 12 mCi, at least 13 mCi, at least 14 mCi, at least 15 mCi, at least 16 mCi, at least 17 mCi, at least 18 mCi, at least 19 mCi, at least 20 mCi, at least 21 mCi, at least 22 mCi, at least 23 mCi, at least 24 mCi, at least 25 mCi, at least 26 mCi, at least 27 mCi, at least 28 mCi, at least 29 mCi, at least 30 mCi, at least 31 mCi, at least 32 mCi, at least 33 mCi, at least 34 mCi, at least 35 mCi, at least 36 mCi, at least 37 mCi, at least 38 mCi, at least 39 mCi, at least 40 mCi, at least 41 mCi, at least 42 mCi, at least 43 mCi, at least 44 mCi, at least 45 mCi, at least 46 mCi, at least 47 mCi, at least 48 mCi, at least 49 mCi, at least 50 mCi, at least 51 mCi, at least 52 mCi, at least 53 mCi, at least 54 mCi, at least 55 mCi. In some embodiments, the total dosage of Pb-212 present in the radiopharmaceutical composition may range from about 0.5 mCi to 5.0 mCi, about 5.0 mCi to 10 mCi, about 10 mCi to 15 mCi, about 20 mCi to 30 mCi, about 15 mCi to 25 mCi, about 25 mCi to 35 mCi, about 30 mCi to 40 mCi, about 35 mCi to 45 mCi, about 40 mCi to 50 mCi, or about 45 mCi to 55 mCi, The dosage may be about 15 mCi, 20 mCi, 25 mCi, 30 mCi, 35 mCi, 40 mCi, 45 mCi, 50 mCi, or 55 mCi.

In one embodiment, the method and device of the invention is designed for automated implementation in a closed system comprising means for eluting Pb-212 from a parent nuclide, means for purifying the Pb-212 with one or more liquid chromatography columns, means for collecting the purified Pb-212, and an electronic program for running automation means for eluting Pb-212 from parent nuclide, means for purifying Pb-212, and means for collecting purified Pb-212.

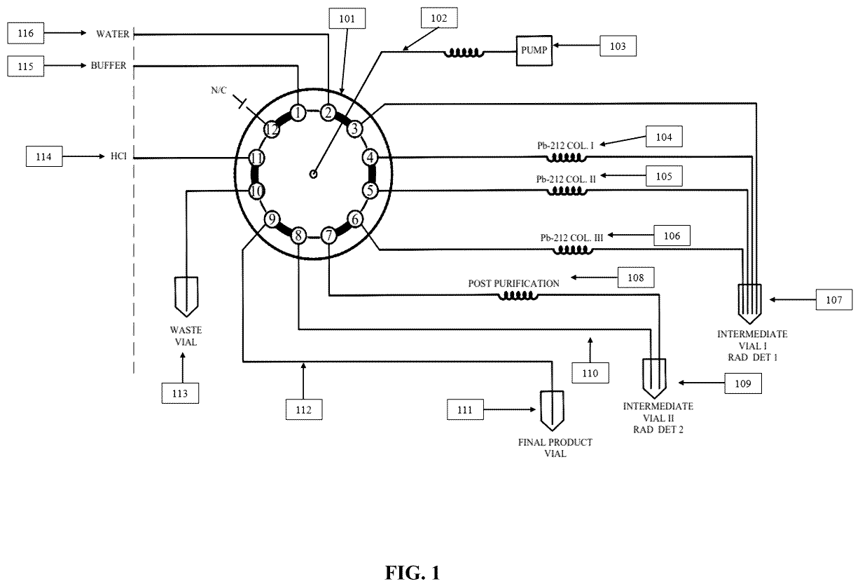

Embodiments of the invention are further detailed in FIGS. 1-3. The embodiments in FIGS. 1-3 depict the capability of the invention to comprise multiple columns and allow the simultaneous elution of large amounts of Pb-212 (for example, up to 100 mCi, or more). With the capacity to accommodate multiple Ra224-loaded columns, the module enables simultaneous elution of up to 100 mCi Pb212. All solvents and eluents needed to conduct all aspects of the purification and column regeneration processes of the invention can be attached to the system at the time of installation or as needed. Further, potential routes of user exposure to radiation (e.g., through columns, intermediate and waste vials, and solution carrying lines) can be shielded using polycarbonate and/or depleted uranium high-density polycarbonate inserts, in each case of useful thickness to block radiation sufficiently to produce levels that are safe for user exposure. In another embodiment, radiation detectors can be used at any point in the process or location on the device to track the efficacy of the purification process. The following is a detailed description of several embodiments of the present invention. Additional implementations of the present invention will be apparent to persons of ordinary skill in the art.

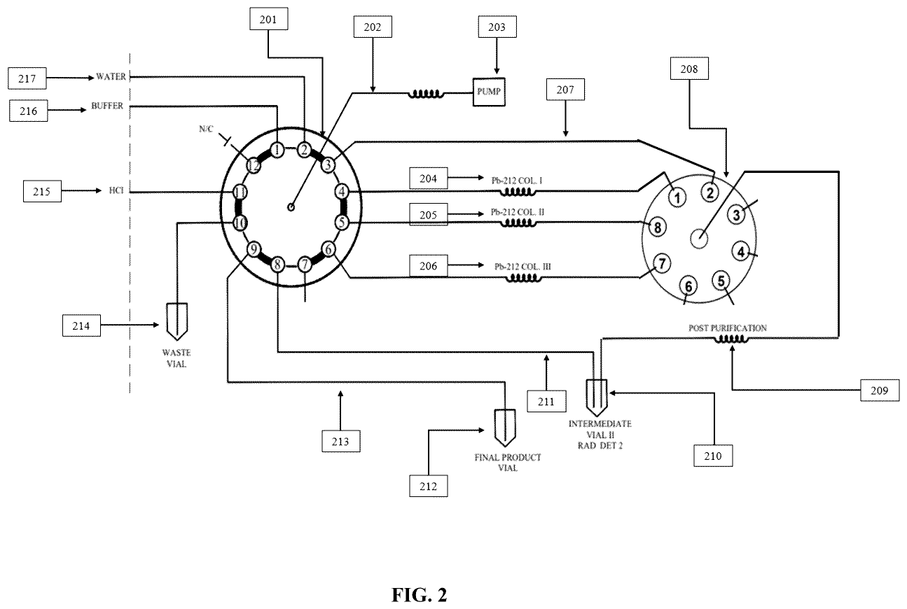

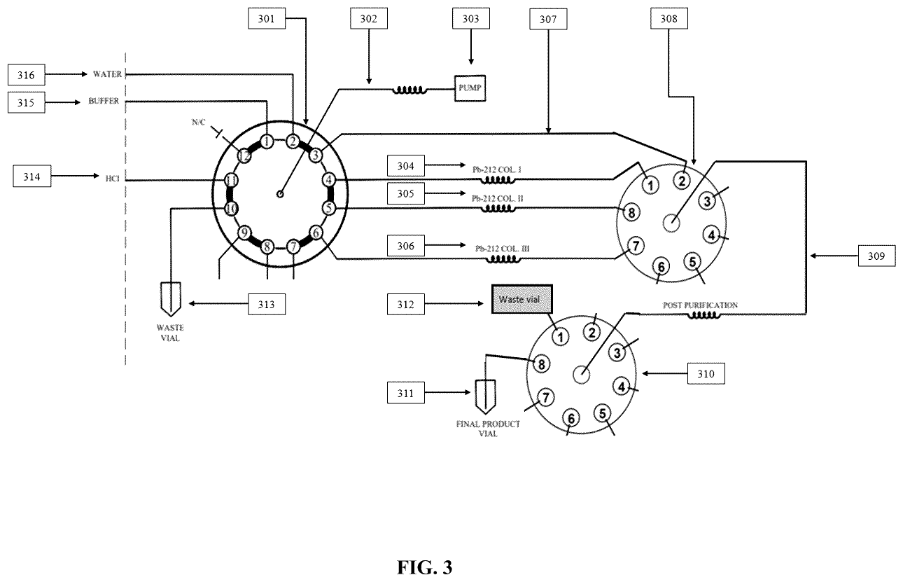

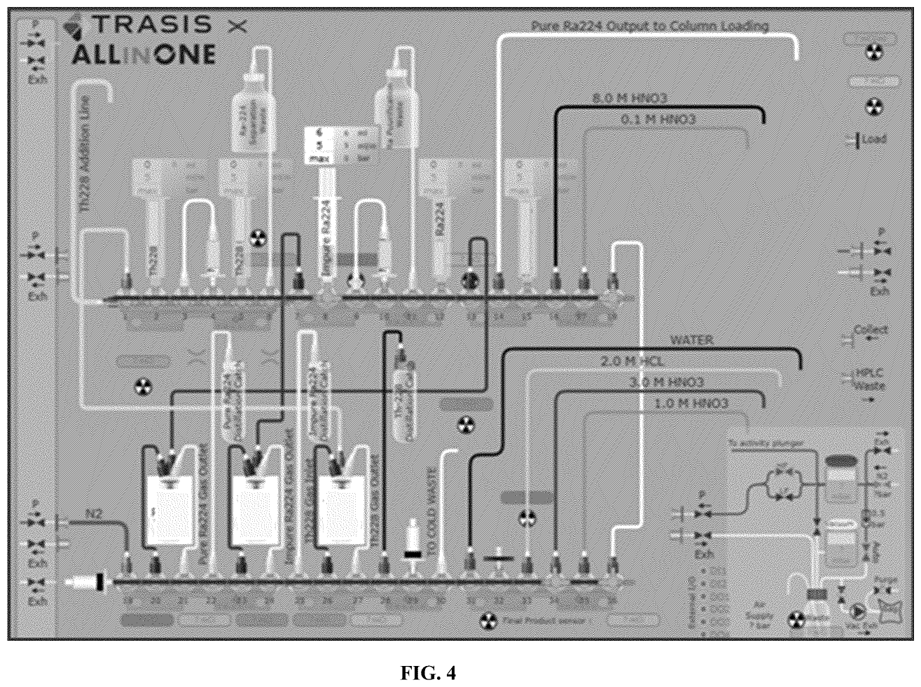

In one embodiment, a purification device as shown in FIGS. 1-3 comprises a multi-port head-valve, e.g. 101, 201, 301. In an embodiment, there may be a single multi-port head-valve (101, FIG. 1). In another embodiment there may be two multi-port head-valves (202, FIG. 2). In a third embodiment there may be three multi-port head-valves (303, FIG. 3). Each multi-port head-valve comprises a number of separate ports which facilitate the movement of liquids through the device. In one embodiment, the multi-port head-valve has at least 6 ports. In another embodiment, the multi-port head-valve has at least 8 ports. In yet another embodiment, the multi-port head-valve has at least 10 ports. In yet another embodiment, the multi-port head-valve has at least 12 ports.

Liquid can be moved through the devices in FIGS. 1-3 by a pump (103, 203, 303) in fluid communication with the multi-port head-valve 101, 201, or 301, and chromatography devices (104-106, 204-206, or 304-306) by way of a central line 102, 202, or 302. The pump (103, 203, 303) facilitates the movement of liquids including water (116, 217, 316), buffer (115, 216, 315), and acid (114, 215, 314) through the device. Buffer 115, 216, 315 may be of a suitable pH that is chemically compatible with a user's chromatography resin of choice and the device. Acid 114, 215, 314 may be any acid of suitable pH that is chemically compatible with a user's chromatography resin of choice and the device. A parent nuclide may be introduced to the system (FIGS. 1-3) in any suitable manner as will be apparent to one of ordinary skill in the art. In one embodiment, the elution of Pb-212 from the Ra-224 generator uses the acid HCl.

In certain embodiments, the injection of that eluted Pb-212 into afferent port 12 of the multi-port head-valve 101, 201, 301 while efferent ports 4, 5, or 6 of that multi-port head-valve 101, 201, 301 cause that injection volume to flow onto Pb-212 columns 104, 204, 304; 105, 205, 305; 106, 206, 306, respectively. Unpurified Pb-212 may be loaded onto those columns 104, 204, 304; 105, 205, 305; 106, 206, 306 either in series or in parallel. The pump 103, 203, 303 and multi-port head-valve 101, 201, 301 may load those columns directly with the injection volume from port 12 of the module 101, 201, 301, or dilute that Pb-212 injection with acid 114, 215, 314 pulled from afferent port 11 of the multi-port head-valve 101, 201, 301. Another example of how to introduce the purification target to the device is on-column decay in which the Ra-224 generator is bound to the appropriate resin within a column (i.e., columns 104, 204, 304; 105, 205, 305; 106, 206, 306) and allowed to decay to Pb-212 before the device begins the purification process. Another example of loading columns 104, 204, 304; 105, 205, 305; 106, 206, 306 with the purification target, Pb-212, is batch loading, wherein the purification target is mixed with the chromatography resin prior to that resin being loaded or packed into the columns 104, 204, 304; 105, 205, 305; 106, 206, 306. In all examples, the chromatography resin is preconditioned with acid 114, 215, 314 and is equilibrated with acid 114, 215, 314 after the purification target has been loaded onto the resin. In another embodiment, the purification target can be added to the column using reverse flow such that the target is bound to the efferent-most theoretical plates of the column when normal flow is resumed, which can reduce the elution volume needed to remove the purification target bound to the chromatography resin, and increase the concentration of the purification target in the eluate.

In an embodiment of the purification process using the device in FIG. 1, the device utilizes a single multi-port head-valve 101 to affect the purification of Pb-212. In this embodiment three Pb-212 purification columns 104, 105, 106 have been equilibrated after being loaded with the purification target. Flow through (FT) from the equilibration with acid 114 is directed to waste vial 113. After equilibration with acid 114, the pump 103 and multi-port head-valve 101 pull water 116 through afferent port 2 of the multi-port head-valve 101 and out efferent ports 4, 5, and 6 of multi-port head-valve 101 and through the Pb-212 columns 104, 105, 106 to adjust the pH. The FT from the columns 104, 105, 106 is directed to the waste vial 113. Next, the pump 101 and multi-port head-valve 103 cause elution buffer 115, or eluent, to be pulled through afferent port 1 of the multi-port head-valve 101, out efferent ports 4, 5, and 6 of that multi-port head-valve 101 and through the Pb-212-loaded columns 104, 105, 106. The presence of eluent within the columns 104, 105, 106 causes the dissociation of Pb-212 from the chromatography resin found within those columns 104, 105, 106 into the eluate, and that Pb-212-containing eluate from each column 104, 105, 106 is deposited into an intermediate vial 107 having a radiation detector to confirm successful elution and optionally radiation shielding. Elution can be affected in “step-off” or fractionation type methods. The pump 103 and multi-port head-valve 101 then cause afferent port 3 of the multi-port head-valve 101 to pull the eluent of columns 104, 105, 106 through the multi-port head-valve 101 and out efferent port 7 of the same multi-port head-valve 101. The device causes the Pb-212 eluates to enter efferent port 7 of the multi-port head-valve 101 which subsequently puts those eluents onto a post purification column 108, which may be colloquially known as a finishing column comprised of any suitable resin. Once the Pb-212 eluates are loaded onto the post purification column 108 that has been preconditioned with acid 114, the multi-port head-valve 101 and pump 103 cause water to flow over post purification column 108—utilizing the afferent port 2 to efferent port 7 loop of the multi-port head-valve 101—to neutralize the pH of post purification column 108. The FT from this pH adjustment step is directed to the waste vial 113. The pump 103 and multi-port head-valve 101 subsequently cause elution buffer 115 to be pulled through afferent port 1 of the multi-port head-valve 101 and out efferent port 7 of the same multi-port head-valve 101, allowing eluent to flow onto the post purification column 108. The presence of eluent on column 108 causes Pb-212 to disassociate from the resin of the post purification column 108, and the Pb-212 eluate is deposited into a second intermediate vial also having a radiation detector 109 and optionally radiation shielding. Lastly, the pump 103 and multi-port head-valve 101 cause the finished Pb-212 eluate to be pulled into afferent line 8 110 of the multi-port head-valve 101, and out efferent line 9 112 of that same multi-port head-valve 101 and into a final product vial 111. After collection of the final product, all columns are regenerated by the pump 103 and multi-port head-valve 101 causing acid 114 to flow over those columns 104-106, 108 with the FT being deposited in the waste vial 113.

Another embodiment of the purification device (FIG. 2), shows two multi-port head-valves 201, 208 and at least three initial Pb-212 columns 204, 205, 206 which are utilized to effect the purification of Pb-212. The device of the embodiment in FIG. 2 includes two sets of head valves with centrally-located, interconnecting columns. Within the purification device the Pb-212 columns are situated between the first 201 and second 208 multi-port head-valve with the afferent end of each column being attached to the first multi-port head-valve 201 and the efferent end of each column being attached to the second multi-port head-valve 208. The Pb-212 purification columns 204, 205, 206 have each been equilibrated with acid after being loaded with the purification target. Flow through (FT) from the equilibration with acid 215 is directed to the waste vial 214. After equilibration with acid 215, the pump 203 and multi-port head-valve 201 pull water 217 through afferent port 2 of the multi-port head-valve 201 and out efferent ports 4, 5, and 6 of that multi-port head-valve 201 and through the Pb-212 columns 204, 205, 206 to adjust the pH. The efferent flow of water from the Pb-212 columns 204, 205, 206 enters afferent ports 1, 8, and 7 of the second multi-port head-valve 208 and out efferent port 2 of the same multi-port head-valve 208. That water then enters afferent port 3 of the first multi-port head-valve 201 and exits efferent port 10 of the same multi-port head-valve 201 where it is discarded into the waste vial 214. When liquid flows from the second multi-port head-valve 208 towards the first multi-port head-valve 201 after coming off of the Pb-212 columns 204, 205, 206, this loop 207 can be called a FT loop 207. When the flow of liquid is in the opposite direction (from the first 201 to the second multi-port head-valve 208), 207 can be called the bypass loop 207. Next, the pump 203 and multi-port head-valve 201 cause elution buffer 216, or eluent, to be pulled through afferent port 1 of the multi-port head-valve 201, out efferent ports 4, 5, and 6 of that multi-port head-valve 201 and over the Pb-212 columns 204, 205, 206. Note that another Pb-212 column may be added to efferent port 7 of the first multi-port head-valve 201 to further increase production. The presence of eluent within the columns 204, 205, 206 causes the dissociation of Pb-212 from the chromatography resin found within those columns 204, 205, 206, and that Pb-212 eluate from each column 204, 205, and 206 enters afferent ports 1, 8, and 7 of the second multi-port head-valve 208, respectively. Those Pb-212 eluates then flow directly onto the post purification column 209. Using the bypass loop 207, the elution buffer is caused to flow into the post purification column 209, causing bound Pb-212 to disassociate from the chromatography resin within column 209, and subsequently be deposited in an intermediate vial having a radiation detector 210 and optionally radiation shielding. The first multi-port head-valve 201 and pump 203 then cause the Pb-212 eluate to move through afferent line 8 of the first multi-port head-valve 211, and out efferent line 9 of that same multi-port head-valve 213, and into the final product vial 212. All columns are then subsequently regenerated using acid 215 and the FT is deposited into the waste vial 214 using the FT loop. It is further worth noting that as currently described, the post purification column 209 is connected to the central line of the second multi-port head-valve 208. However, that afferent portion of that column 209 could just as easily be connected to other ports (e.g. 3-6) of that multi-port head-valve 208 with the efferent end connected to the main line of the multi-port head-valve 208, such as if another Pb-212 column was also added.

In yet another embodiment of the purification device (FIG. 3), the second embodiment (the preceding paragraph) can be further modified by inserting a third multi-port head-valve 310 between the efferent end of an at least one post purification column 309 and the final product vial 311. This configuration would also allow for additional post purification columns 309 to be added between the second multi-port head-valve 308 and third multi-port head-valve 310. In this embodiment, there is also a waste vial 312 in which FT from the third multi-port head-valve 308 may be deposited, in addition to the waste vial 313 found off of efferent port 10 of the first multi-port head-valve 301. This allows for the at least one post purification column 309 to be washed, and equilibrated with acid 314, and water 316 using the bypass loop 307 prior to elution using the buffer 315 eluent. Accordingly, this embodiment may provide an even more pure product. All purification steps of this embodiment follow the same methods as those described for the second embodiment, except for the following: the aforementioned ability to wash and equilibrate the at least one post purification column; the waste vial 312 found downstream of efferent port 1 of the third multi-port head-valve 310; washing, equilibration, and elution of the at least one post purification column 309 takes place by utilizing the bypass loop 307; and the final product vial 311 is located downstream of efferent port 8 of the third multi-port head-valve 310.

In another embodiment, the invention comprises a housing for components of the device. For example, any or all of the devices shown in FIGS. 1-3 can be contained within a housing. FIG. 11(a)-(c) depict different views of a housing for valve ports of the invention.

The purified Pb-212 of the invention can be used as a radiolabel in a radiopharmaceutical. In one embodiment, the Pb-212 can be coordinated to a chelator that comprises a targeting ligand. The chelator may be selected from the group consisting of DOTA, DOTAM, TCMC, and derivatives thereof, or other compounds appreciated by one of skill in the art.

### EXAMPLES

### Example 1: Purification of Th-228 and Ra-224

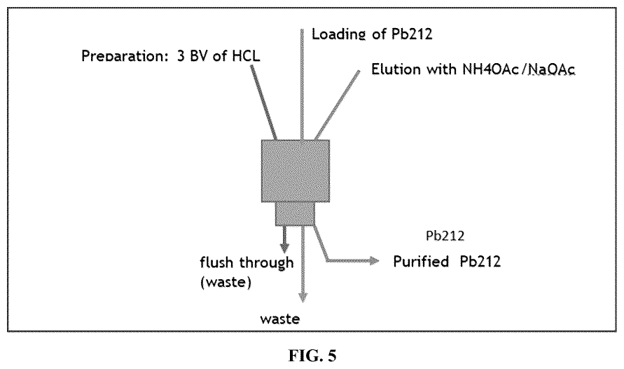

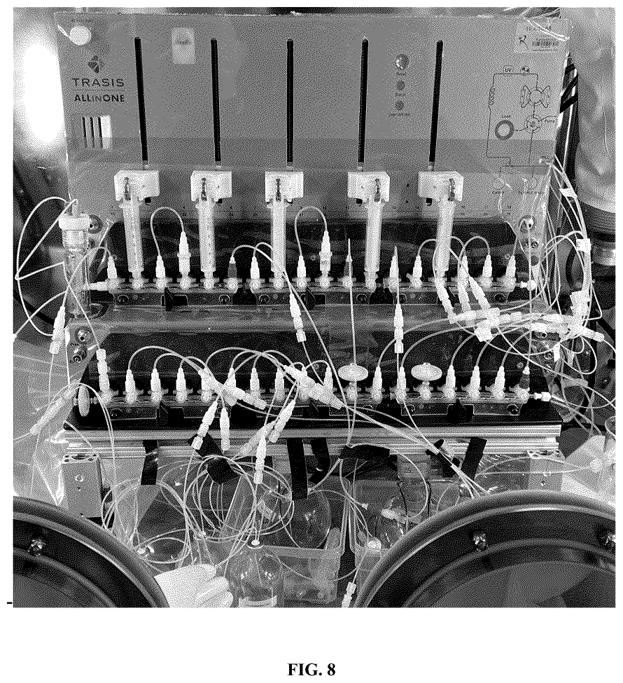

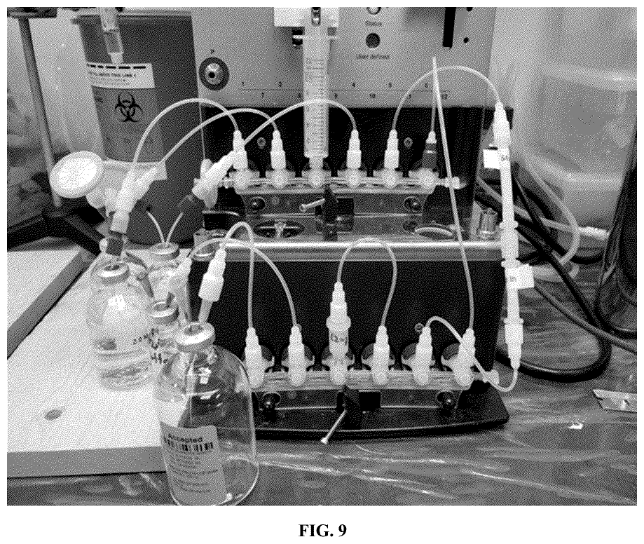

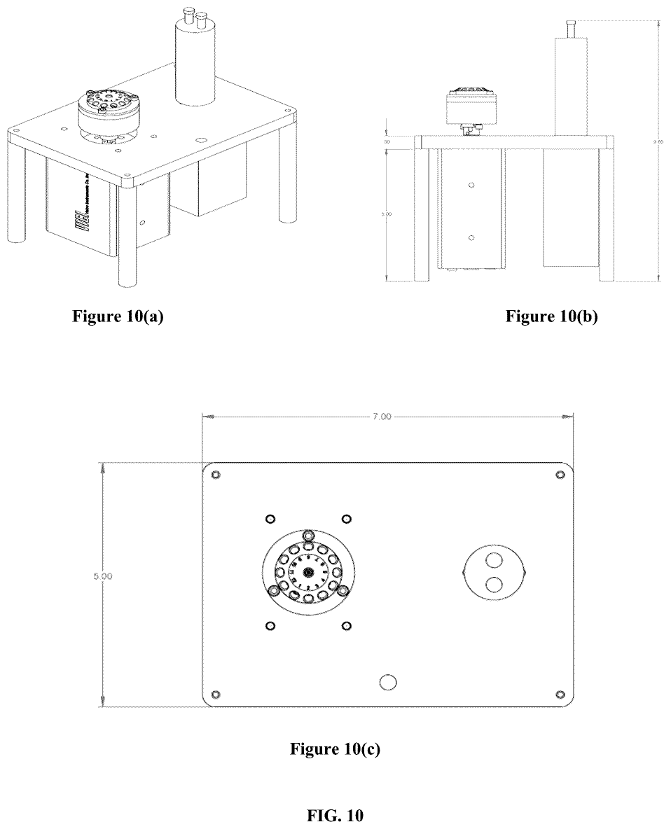

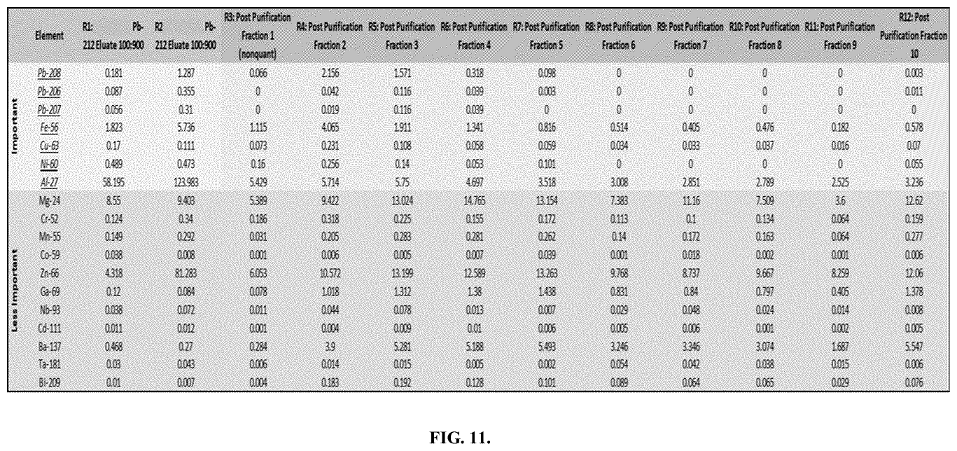

An automated cassette-based system was used for the purification of Th-228 and Ra-224. This 21 CFR compliant system consisted of AGMP1 and AMP50 resin used for Th-228 and Ra-224 respectively. FIG. 4 depicts a schematic layout of a sequence used for purification of Th-228 and Ra244. FIG. 8 depicts a device and corresponding flow paths of connections in an automated system embodying the schematic in FIG. 4, for the generation of crude Ra-224 from Th-228, and subsequent purification of the crude Ra-224 to produce purified Ra-224 that is suitable for use in the production of Pb-212.

### Example 2: Specification of Pb-212 Eluted from Ra-224/Pb-212 Generator

Radionuclide analysis of Pb-212 purity was performed using high-resolution gamma-ray spectroscopy using an HPGe detector (Canberra) to identify daughter isotopes of Pb-212 (Bi-212, TI-208) and any potential breakthrough of parent isotopes Ra-224 and Th-228.

TABLE 1
Radionuclide identification of Pb-212

| | | Wt mean | Wt mean | |
|---|---|---|---|---|
| Nuclide | Nuclide Id | Activity | Activity | |
| Name | Confidence | (μCl/units) | Uncertainty | Comments |
| Tl-208 | 0.999 | 2.87E−01 | 2.42E−03 | |
| Bl-212 | 0.781 | 6.47E−01 | 5.98E−03 | |
| PB-212 | 1.000 | 7.75E−01 | 1.05E−02 | |
| Rn-220 | 0. [symbol] | 1.16E+00 | 6.00E−02 | |
| R [symbol] -224 | 1.000 | 1.49E+00 | 3. [symbol] E−02 | |
| Th-228 | 0.583 | 1. [symbol] 7E−01 | 7. [symbol] E−03 | |

? = nuclide is part of an undetermined solution
X = nuclide rejected by the interference analysis
@ = nuclide contains energy lines not [symbol] in Weighted Mean Activity
Errors quoted at 1.000sigma [symbol]
indicates data missing or illegible when filed

### Example 3: Chemical Characterization of Pb-212

The chemical purity of Pb-212 eluate was determined using inductively coupled plasma mass spectrometry (ICPMS). A multi-element standard was used to determine content of the most common, stable impurities in Pb-212, which could have a negative effect on the radiolabeling reaction. The trace metal analysis of Pb-212 has shown moderate to low content of Fe, Cu and Ni. Key metals that can affect the radiolabeling yield of labeling with Pb-212 were analyzed (Iron Fe-56, Copper Cu-63, Lead Pb-208, Pb-206 and Pb-207), in addition to others. The content of these metals in the eluate was below 7.7-18 ug/L with the highest value reported for iron. None of these metals had an effect on radiolabeling at the detected levels. The metal content was further reduced in post-purified Pb-212. Table 2 below provides more detailed information on a trace metal analysis of Pb-212 eluted from Ra-224-AMP50 resin according to a process of the invention. The metal content of eluate was monitored over the lifetime of the Ra-224/Pb-212 generator (shown in Table 2), and during a use of the generator (shown in Table 3).

TABLE 2
ICPMS trace metal analysis of Pb-212 eluate
monitored over the lifetime of the generator.

| | | R1: Pb-212 | R2: Pb-212 | R3: Pb-212 |
|---|---|---|---|---|
| | | Eluate | Eluate | Eluate |
| | Element | 100:900 | 100:900 | 100:900 |
| Important | Pb-208 | 0.066 | 0.066 | 0.588 |
| | Pb-206 | 0.042 | 0.042 | 0.311 |
| | Rb-207 | 0.028 | 0.028 | 0.251 |
| | Fe-56 | 1.913 | 1.913 | 7.669 |
| | Cu-63 | 0.087 | 0.087 | 0.61 |
| | Ni-60 | 0 | 0.385 | 0.251 |
| | Al-27 | 40.858 | 235.145 | 232.057 |
| Less | Mg-24 | 0.776 | 2.721 | 2.129 |
| Important | Cr-52 | 0.034 | 0.4 | 0.33 |
| | Mn-55 | 0.042 | 0.351 | 0.243 |
| | Co-59 | 0.006 | 0.084 | 0.083 |
| | Zn-66 | 0.268 | 19.029 | 2.479 |
| | Ga-69 | 0.074 | 0.592 | 0.622 |
| | Nb-93 | 0.008 | 0.009 | 0.012 |
| | Cd-111 | 0.002 | 0.004 | 0.003 |
| | Ba-137 | 0.262 | 2.04 | 2.122 |
| | Ta-181 | 0.004 | 0.002 | 0.002 |
| | Bi-209 | 0.003 | 0.003 | 0.001 |

TABLE 3
ICPMS trace metal analysis of Pb-212 eluates
monitored during a use of the generator

| | | R1: Pb-212 | R2: Pb-212 | R3: Pb-212 | R4: Pb-212 |
|---|---|---|---|---|---|
| | | Eluate | Eluate | Eluate | Eluate |
| | Element | 100:900 | 100:900 | 100:900 | 100:900 |
| Important | Pb-208 | 0.066 | 0.066 | 0.588 | 0.535 |
| | Pb-206 | 0.042 | 0.042 | 0.311 | 0.274 |
| | Pb-207 | 0.028 | 0.028 | 0.251 | 0.229 |
| | Fe-56 | 1.913 | 1.913 | 7.669 | 18.27 |
| | Cu-63 | 0.087 | 0.087 | 0.61 | 0.39 |
| | Ni-60 | 0 | 0.385 | 0.251 | 0.945 |
| | Al-27 | 40.858 | 235.145 | 232.057 | 125.884 |
| Less | Mg-24 | 0.776 | 2.721 | 2.129 | 1.989 |
| Important | Cr-52 | 0.034 | 0.4 | 0.33 | 1.03 |
| | Mn-55 | 0.042 | 0.351 | 0.243 | 0.351 |
| | Co-59 | 0.006 | 0.084 | 0.083 | 0.113 |
| | Zn-66 | 0.268 | 19.029 | 2.479 | 2.246 |
| | Ga-69 | 0.074 | 0.592 | 0.622 | 0.428 |
| | Nb-93 | 0.008 | 0.009 | 0.012 | 0.005 |
| | Cd-111 | 0.002 | 0.004 | 0.003 | 0.002 |
| | Ba-137 | 0.262 | 2.04 | 2.122 | 1.584 |
| | Ta-181 | 0.004 | 0.002 | 0.002 | 0.001 |
| | Bi-209 | 0.003 | 0.003 | 0.001 | 0.002 |

### Example 4: Purification of Pb-212 Using TK201 Resin

### Description of TK201 Resin (Triskem)

TK201 resin (referred to as “TK resin” in this Example 4) comprises a tertiary amine structure and contains a small amount of long-chained alcohols that serve as a radical scavenger and increase the radiolytic stability of the TK resin. The resin acts as a weak ion pair binding agent and allows the elution of isotopes under mild conditions.

### Applications of TK201 Resin

The resin can serve for separation of multiple isotopes including Cu isotopes (high selectivity for separation of Cu over Ni, Zn, Ga), technetium, rhenium and lead isotopes (Pb-203, Pb-212).

### Physical and Chemical Properties of TK201 Resin

The density of resin is 0.35 g/mL.

### Protocol for Purification of Pb-212 Using a Manual Approach

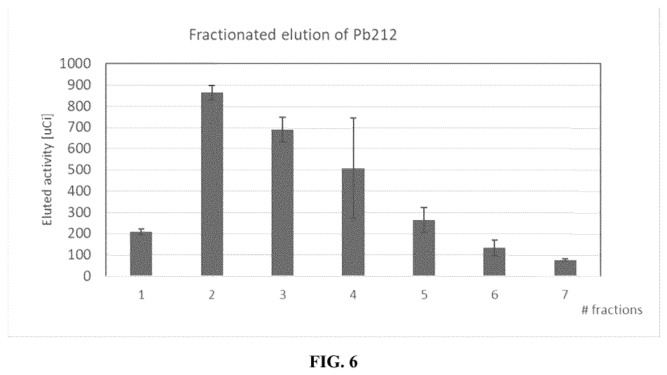

TK resin (60 mg/run) was packed manually into a cartridge/column and pre-conditioned with 3 bed volumes (BV) of acid (1M HCl or 2M HCl) prior to elution of the generator. The Pb-212 chloride (2-3 ml in 2M HCl) eluted from generator was loaded on the resin with a flowrate in the order of 0.5-1 BV/min. The activity of the flow through eluate passing through TK resin was determined using the dose calibrator to evaluate the yield of retention of Pb-212. The flow through was then directed to waste. The Pb-212-bound TK resin was washed with 0.5-1 ml ultrapure trace metal free water. Flow through activity was counted on the dose calibrator and collected into a separate vial. The purified Pb-212 was eluted from TK resin using 0.4 M sodium or ammonium acetate buffer at pH 6.0 directly into a reaction vessel and used for radiolabeling. Purified Pb-212 can be fractioned to reduce the volume in the labeling reaction. The pH of Pb-212 eluted from TK resin was in the optimal range of 5.9-6.1 for the labeling reaction. The TK resin loaded cartridges were regenerated after each run by flushing/pre-conditioning with 2M HCl. The scheme in FIG. 5 describes the step-by step purification of Pb-212.

### Fractionation of Pb-212 Using a Manual Approach

The experiments were performed with 1-8 mCi of Pb-212 purified on TK201 resin. Pb-212 was eluted using 0.4-0.5 M Sodium Acetate buffer at pH=5.8-6.0, or 0.4-0.5M Ammonium Acetate buffer at pH=5.8-6.0. The multiple fractions were collected (100-130 ul/per vial). The activity of each fraction was recorded, and the pH of the eluate was determined. The initial three fractions were discarded, and all following fractions were collected. The collected fractions were used directly for labeling without the need for further adjusting of pH. The highest activity of Pb-212 was observed in collected fractions 1-3 (FIG. 6).

### Post-Purification of Pb-212

### Radiochemical Yield of Retention and Elution of Pb-212

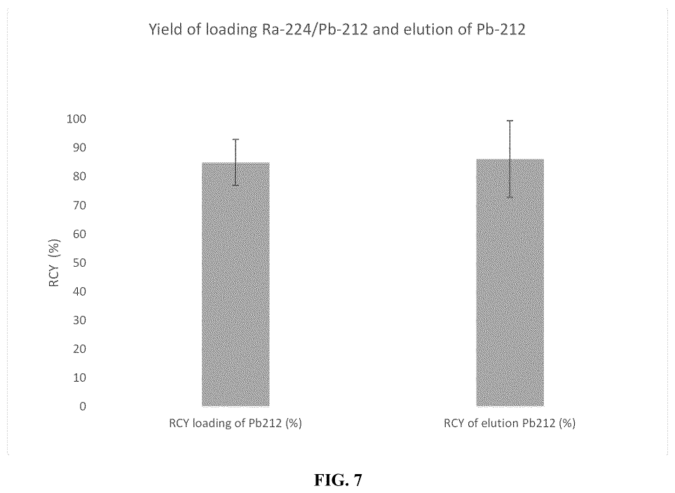

The radiochemical yield of retention (RCY) of Pb-212 on TK resin was 85±8%. The yield of elution of Pb-212 in 0.4-0.5N NaOAc or NH₄OAc buffer pH-6.0 was 86±13%. Table 4 below shows examples of RCY (%) loading and elution of Pb-212 during multiple production runs of Ra-224/Pb-212. The pre-purification column showed consistent retention and recovery of Pb-212 (FIG. 7).

TABLE 4
RCY of retention and elution of Pb-212 from TKI resin

| | | | | | | | AVR RCY % | SDev |
|---|---|---|---|---|---|---|---|---|
| RCY loading ndc [%] | 91.95 | 76.31 | 96.82 | 77.59 | 83.03 | 83.97 | 84.94 | 8.04 |
| RCY elution ndc [%] | 69.97 | 88.54 | 91.35 | 97.42 | 70.03 | 99.58 | 86.15 | 13.13 |

### Chemical Characterization of Pb-212

Chemical purity of Pb-212 was determined using inductively coupled plasma mass spectrometry (ICPMS). A multi-element standard was used to determine the content of the common stable impurities in the purified Pb-212 that could have a negative effect on radiolabeling reaction. Fe, Cu, Zn, and Pb were found in low amounts and their content was higher in the first collected fraction. The Table 5 (shown in FIG. 11) below provides a summary of the trace metal analysis of Pb-212 fractions (see FIG. 11, TABLE 5—ICP-MS trace metal analysis of Pb 212 fractions). Table 6 below summarizes the trace metal analysis of post-purified crude eluate Pb-212. Several fold reductions in the content of the metals tested are seen after post-purification of the crude eluate Pb-212 (for example 1.2-fold reduction in nickel (Ni-60) content and 2281-fold reduction in aluminum (Al-27) content).

TABLE 6
ICP-MS trace metal analysis of Pb-212 eluted from a Ra-224/Pb-212 generator and ICPMS of Pb-212 post-purified fractions.

| | | | | | | | Reduction |
|---|---|---|---|---|---|---|---|
| | | | | | | | of metal |
| | | | | | | | content |
| | | R1: | R2: | R3: No Post | R5: Eluted in | R6: Eluted in | after post- |
| | | Elution | Elution | Purification | 2.0M HCl | 0.4M NaOAc | purification |
| | Element | (ug/L) | (ug/L) | (ug/L) | (ug/L) | Buffer (ug/L) | R3/R6 |
| Impor- | Pb-208 | 2.818 | 4.065 | 1.313 | 0.364 | 0.05 | 26.3 |
| tant | Pb-206 | 1.543 | 0.745 | 0.534 | 0.397 | 0.053 | 30.3 |
| | Pb-207 | 1.419 | 0.578 | 0.463 | 0.365 | 0.061 | 7.6 |
| | Cu-63 | 0.616 | 0.24 | 0.151 | 0.383 | 0.194 | 0.8 |
| | Ni-60 | 7.154 | 0.515 | 0.512 | 0.397 | 0.422 | 1.2 |
| | Al-27 | 624.659 | 505.03 | 310.289 | 157.353 | 0.136 | 2281.5 |
| Less | Mg-24 | 30.692 | 23.552 | 10.925 | 32.22 | 14.321 | 0.8 |
| Impor- | Cr-52 | 13.966 | 1.04 | 0.382 | 0.39 | 1.441 | 0.3 |
| tant | Mn-55 | 3.036 | 1.009 | 0.532 | 1.71 | 1.748 | 0.3 |
| | Co-59 | 0 | 0 | 0 | 0 | 0 | 0.0 |
| | Zn-66 | 318.111 | 373.701 | 190.614 | 539 | 7.601 | 25. |
| | Ga-69 | 0.71 | 0.503 | 0.532 | 10.836 | 4.459 | 0.3 |
| | Nb-93 | 0.103 | 0.055 | 0.02 | 0.037 | 0.004 | 5.0 |
| | Cd-111 | 0.01 | 0.012 | 0.005 | 0.008 | 0.002 | 2.5 |
| | Total Pb (ug/L) | 2.24094 | 2.563947672 | 0.9545289 | 0.378715818 | 0.054050256 | |
| | Total Pb (ug) | 0.009177546 | 0.012779484 | 0.001961557 | N/A | N/A | |
| | Specific Activity (mCi/ug) | 182074.8225 | 109550.5858 | 152939.7397 | | | |

### Automated Post-Purification of Pb-212

The Pb-212 elution of the generator was done using 2.0 M HCl. Pre-conditioning of TK resin was done prior to elution of the generator. The Pb-212 eluate was loaded on the preconditioned TK201 resin and the flow through was directed to waste. The resin was then neutralized with 0.1-0.5 ml of ultrapure trace metal free water to adjust pH of subsequent fractions of Pb-212. The final purified Pb-212 was eluted on 0.4-0.5 M sodium or ammonium acetate buffer pH-5.9-6.1 directly to the reaction vessel containing active pharmaceutical ingredient (API) dissolved in buffer pH-6.0. The column was regenerated after each run by flushing with 2 mL of water and 6V of 2M HCl. The layout of elution and purification of Pb-212 is shown in FIG. 9. A step by step description of the Pb-212 post-purification process is provided in Table 7.

TABLE 7
Step-by-step description of post- purification of Pb-212
using automated approach.

| Step | Description | Rate | | Faults if |
|---|---|---|---|---|
| Conditioning | 4.0 mL of 2.0M HCl drawn into syringe I | 5.0 | mL/min | N/A |
| Conditioning | 4.0 mL of 2.0M HCl pushed through | 1.0 | mL/min | pressure |
| | post-purification resin to waste | | | >2 bar |
| Elution/ | 2.0 mL of 2.0M HCl drawn into syringe I | 5.0 | mL/min | N/A |
| Loading | | | | |
| Elution/ | 2.0 mL of 2.0M HCl pushed through main, | 1.0 | mL/min | pressure |
| Loading | secondary, and post-purification columns | | | >2 bar |
| | to waste | | | |
| Purge column | 2.0 mL of air drawn into syringe I | 5.0 | mL/min | N/A |
| Purge column | 2.0 mL of air pushed through main, | 1.0 | mL/min | pressure |
| | secondary, and post-purification columns | | | >2 bar |
| | to waste | | | |
| Water flush | 2.0 mL of water drawn into syringe II | 5.0 | mL/min | N/A |
| Water flush | 2.0 mL of water pushed through post | 1.0 | mL/min | pressure |
| | purification column to waste | | | >2 bar |
| Elution w/ | 4.0 mL of buffer drawn into syringe II | 5.0 | mL/min | N/A |
| fractionation | | | | |
| Elution w/ | (4.0 − (X + Y)) mL of buffer pushed through | 1.0 | mL/min | pressure |
| fractionation | post purification column to waste | | | >2 bar |
| Elution w/ | X mL of buffer pushed through post | 1.0 | mL/min | pressure |
| fractionation | purification column to Pure Pb-212 | | | >2 bar |
| | outlet vial | | | |
| Elution w/ | Y mL of buffer pushed through post | 1.0 | mL/min | pressure |
| fractionation | purification column to waste | | | >2 bar |

### Automated Module for Production and Post-Purification of Pb-212

RAHA system is a software operated automated module used for reproducible production and purification of high activity of Pb-212. This versatile system can accommodate multiple Ra-224/Pb-212 generators and allows for sequential elution of Pb-212. To reduce radiation exposure, the bench-top system utilizes tungsten and depleted uranium shielding. There are three radiation dose detectors to record differential activity eluted from the generator, loaded on the TK resin, and transferred to a reaction vessel.

All references cited herein are hereby incorporated by reference. The foregoing is offered primarily for purposes of illustration. It will be readily apparent to those skilled in the art that the invention is not limited to the above embodiments and additional methods and embodiments exist as will be apparent to those skilled in the art, and that the shapes, components, additives, proportions, methods of formulation, processes and other parameters described herein can be modified further or substituted in various ways without departing from the spirit and scope of the invention.

What is claimed is:

1. A device for producing Pb-212 from a parent radionuclide comprising:
a first solid media comprising a parent radionuclide and resin, wherein the parent radionuclide generates Pb-212 by radioactive decay; and
a second solid media comprising Pb-212 and resin, wherein elution of the Pb-212 from the second solid media produces purified Pb-212, and wherein the purified Pb-212 is between 1-100 mCi.

2. The device of claim 1 wherein said parent nuclide is Th-228 or Ra-224.

3. The device of claim 1 wherein the first solid media is housed in a first column and the second solid media is housed in a second column.

4. The device of claim 3 comprising two or more first columns or two or more second columns.

5. The device of claim 3 or 4 wherein the first and second columns comprise radiation shielding.

6. The device of claim 3 wherein the first and second columns are connected in series or in parallel.

7. The device of claim 4 wherein the first columns are connected in series or in parallel.

8. The device of claim 4 wherein the second columns are connected in series or in parallel.

9. The device of claim 3 wherein the device comprises one to five first columns and one second column.

10. The device of claim 1 further comprising a radiation detector.

11. The device of claim 1 wherein the resin is a cation exchange resin.

12. The device of claim 1 wherein the resin comprises a tertiary amine.

13. The device of claim 12 wherein the resin is TK201 resin.

14. The device of claim 1 wherein the purified Pb-212 has a purity greater than about 95.0%.

15. The device of claim 1 wherein the device is automated.

16. The device of claim 15 comprising a multi-port head-valve, wherein the multi-port head-valve comprises separate ports which facilitate the movement of liquids through the device.

17. The device of claim 16 comprising a pump in fluid communication with the multi-port head-valve and the first or second solid media.

18. The device of claim 16 wherein the first solid media is housed in a first column and the second solid media is housed in a second column.

19. The device of claim 18 wherein the first and second columns comprise radiation shielding.

20. The device of claim 18 wherein the first and second columns are connected in series or in parallel.

21. The device of claim 18 wherein the second columns are connected in series or in parallel.

22. The device of claim 18 further comprising a radiation detector.

23. The device of claim 16 wherein the resin is a cation exchange resin.

24. The device of claim 16 wherein the resin comprises a tertiary amine.

25. The device of claim 24 wherein the resin is TK201 resin.

26. The device of claim 22 further comprising a software operated automated module that controls the device for production and purification of Pb-212.

27. A device for purifying Ra-224 generated from a second parent radionuclide comprising:
a first solid media comprising a second parent radionuclide and resin, wherein the second parent radionuclide generates Ra-224 by radioactive decay;
a second solid media comprising Ra-224, wherein elution of the Ra-224 from the second solid media produces purified Ra-224 that can be loaded onto a third solid media.

28. The device of claim 27 wherein the second parent radionuclide is Th-228.

29. The device of claim 27 wherein the first solid media is housed in a first column and the second solid media is housed in a second column.

30. The device of claim 29 comprising two or more first columns or two or more second columns.

31. The device of claim 29 or 30 wherein the columns are connected in series or in parallel.

32. The device of claim 27 wherein the resin is a cation exchange resin.

33. The device of claim 27 wherein the device is automated.

34. A method for purifying Pb-212 comprising the steps of:
a. pre-conditioning a resin with an acid solution to produce a pre-conditioned resin;
b. loading Pb-212 onto the pre-conditioned resin to produce a loaded pre-conditioned resin;
c. washing the loaded pre-conditioned resin using water;
d. eluting Pb-212 from the loaded pre-conditioned resin using a buffer to produce purified Pb-212; and
e. collecting the purified Pb-212.

35. The method of claim 34 wherein the Pb-212 loaded onto the pre-conditioned resin is Pb-212 chloride and the acid solution is 1M or 2M HCl.

36. The method of claim 34 wherein the buffer is sodium or ammonium acetate buffer.

37. The method of claim 34 wherein the buffer is at a pH from 5.8 to about 6.2.

38. The method of claim 37, wherein the pH is about 6.0.

39. The method of claim 34 wherein the buffer is from about 0.3M to about 0.6 M

40. The method of claim 39 wherein the buffer is from about 0.4 to about 0.5 M.

41. The method of claim 34, wherein the method is automated.

42. An automated method for purifying Pb-212 comprising the steps of:
a. providing a device of claim 17;
b. introducing Pb-212 into the device and the second solid media;
c. pre-conditioning and equilibrating the second solid media with acid;
d. pumping acid through the second solid media;
e. pumping water through the second solid media;
f. pumping buffer through the second solid media to generate an eluate; and
g. collecting purified Pb-212 from the eluate.

43. The method of claim 42, wherein the buffer is sodium or ammonium acetate buffer.

44. The method of claim 42 wherein the buffer is at a pH from 5.8 to about 6.2.

45. The method of claim 44, wherein the pH is about 6.0.

46. The method of claim 42 wherein the buffer is from about 0.3M to about 0.6 M

47. The method of claim 46 wherein the buffer is from about 0.4 to about 0.5 M.

48. The method of claim 42 wherein the resin is a cation exchange resin.

49. The method of claim 42 wherein the resin is TK201 resin.

50. The method of claim 42 wherein the purified Pb-212 has about 100 mCi.

51. The method of claim 42, wherein the first solid media is housed in a first column and the second solid media is housed in a second column, the first and second columns comprise radiation shielding, the device further comprises a radiation detector, and the device further comprises a software operated automated module that controls the device for production and purification of Pb-212.
